(19) United States
(12) Patent Application Publication
(10) Pub. No.: US 2026/0210287 A1
(43) Pub. Date: Jul. 23, 2026

(54) TURBOCHARGER

(71) Applicant: IHI Corporation, Tokyo (JP)

(72) Inventors: Taiki YOSHIZAKI, Tokyo (JP); Kenichi SEGAWA, Tokyo (JP)

(73) Assignee: IHI Corporation, Tokyo (JP)

(21) Appl. No.: 19/569,014

(22) Filed: Mar. 17, 2026

Related U.S. Application Data
(63) Continuation of application No. PCT/JP2024/031296, filed on Aug. 30, 2024.

(30) Foreign Application Priority Data
Nov. 10, 2023 (JP) 2023-192304

(51) Int. Cl. F02C 6/12

(52) U.S. Cl. CPC F02C 6/12; F05D 2220/40; F05D 2240/128; F05D 2260/50

(57) ABSTRACT

The turbocharger includes a support ring and a drive ring that rotates around the support ring. The drive ring includes an inner circumferential surface that contacts the support ring, and a first end face and a second end face in an axial direction. The first end face is positioned closer to an annular flow path where a plurality of nozzle vanes are arranged, with respect to the second end face in the axial direction. The drive ring includes, in a cross-section along an axis, a first shape that connects the inner circumferential surface to the first end face.

### CROSS REFERENCE TO RELATED APPLICATIONS

This application is a continuation application of International Application No. PCT/JP2024/031296, filed on Aug. 30, 2024, which claims priority to Japanese Patent Application No. 2023-192304 filed on Nov. 10, 2023, the entire contents of which are incorporated herein by reference.

### BACKGROUND ART

### Technical Field

The present disclosure relates to a turbocharger.

A turbocharger may include a mechanism for adjusting a cross-sectional area of a turbine flow path. For example, Patent Literature 1 discloses a turbocharger including a nozzle drive mechanism. The nozzle drive mechanism adjusts a width of a flow path in a turbine housing. The flow path has an annular shape around a central axis of a turbine impeller. The nozzle drive mechanism includes a plurality of nozzle vanes. The plurality of nozzle vanes are arranged in the annular flow path along a circumferential direction. Each nozzle vane rotates around an axis parallel to the central axis of the turbine impeller. The width of the flow path is adjusted by simultaneously rotating the plurality of nozzle vanes. The nozzle drive mechanism includes a drive ring for simultaneously rotating the plurality of nozzle vanes. The drive ring slides and rotates around a drive ring support.

### CITATION LIST

### Patent Literature

Patent Literature 1: JP 2020-165374 A

### SUMMARY

### Technical Problem

The aforementioned mechanism may be subject to wear due to the rotation of the drive ring.

The present disclosure aims to provide a turbocharger that can reduce wear caused by rotation of a drive ring.

### Solution to Problem

In order to solve the above problem, a turbocharger according to one aspect of the present disclosure includes a turbine impeller, a housing that accommodates the turbine impeller and that includes an annular flow path formed radially outside the turbine impeller, a plurality of rotatable nozzle vanes that are arranged in the annular flow path along the circumferential direction of the turbine impeller, a support ring that has an annular shape around an axis of the turbine impeller and that is accommodated in the housing, and a drive ring that has an annular shape around the axis of the turbine impeller and that rotates around the support ring to simultaneously rotate the plurality of rotatable nozzle vanes, the drive ring including an inner circumferential surface that contacts the support ring, and a first end face and a second end face in the axial direction of the turbine impeller, the first end face being positioned closer to the annular flow path with respect to the second end face in the axial direction, the drive ring including, in a cross-section along the axis of the turbine impeller, a first R-shape that connects the inner circumferential surface to the first end face.

The first R-shape may be connected to the inner circumferential surface by a tangent of the first R-shape in the aforementioned cross-section.

In the aforementioned cross-section, a radius of curvature of the first R-shape may be 6% or more of a width of the drive ring in the axial direction.

In the aforementioned cross-section, the radius of curvature of the first R-shape may be 45% or less of the width of the drive ring.

The drive ring may include, in the aforementioned cross-section, a second R-shape that connects the inner circumferential surface to the second end face.

The support ring may include a plurality of protrusions that protrude in the axial direction and that contact the inner circumferential surface of the drive ring, each of the plurality of protrusions may include an outer surface that contacts the inner circumferential surface of the drive ring, and a third end face and a fourth end face in the circumferential direction, and each of the plurality of protrusions may include, in a cross-section perpendicular to the axis of the turbine impeller, a third R-shape that connects the outer surface to the third end face and a fourth R-shape that connects the outer surface to the fourth end face.

Alternatively, in the cross-section perpendicular to the axis of the turbine impeller, each of the plurality of protrusions may include a third chamfer that connects the outer surface to the third end face and a fourth chamfer that connects the outer surface to the fourth end face.

### EFFECTS

According to the present disclosure, wear caused by the rotation of the drive ring can be reduced.

### BRIEF DESCRIPTION OF DRAWINGS

FIG. 1 is a schematic cross-sectional view of a turbocharger according to an embodiment.

FIG. 2 is a schematic exploded perspective view of a nozzle drive mechanism.

FIG. 3 is a schematic perspective view of the nozzle drive mechanism after assembly.

FIG. 4 is a schematic perspective view after assembly which includes cross-sections of a drive ring and a first protrusion obtained along line a-a and line b-b in FIG. 2.

FIG. 5 is a graph showing a relationship between a size of R-shape and a specific pressure ratio.

FIG. 6A is a schematic cross-sectional view showing the drive ring after press forming and before barrel polishing.

FIG. 6B is a schematic cross-sectional view showing the drive ring after barrel polishing.

FIG. 7A is an example of a cross-sectional view of the first protrusion obtained along line c-c in FIG. 2. FIG. 7B is another example of a cross-sectional view of the first protrusion obtained along line c-c in FIG. 2.

### DESCRIPTION OF EMBODIMENTS

An embodiment of the present disclosure will be described in detail below with reference to the accompanying drawings. Specific dimensions, materials, and numerical values described in the embodiment are merely examples for better understanding, and do not limit the present disclosure unless otherwise specified. In this specification and the drawings, duplicate explanations are omitted for elements having substantially the same functions and configurations by assigning the same sign. Furthermore, elements not directly related to the present disclosure are omitted from the figures.

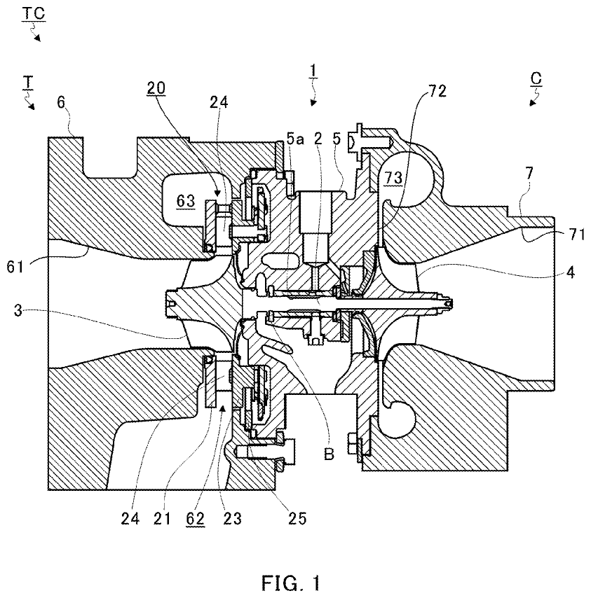

FIG. 1 is a schematic cross-sectional view of a turbocharger TC according to an embodiment. The turbocharger TC includes a housing 1, a shaft 2, a turbine impeller 3, and a compressor impeller 4.

As described later, the turbine impeller 3 and the compressor impeller 4 rotate integrally with the shaft 2. Accordingly, in the present disclosure, an axial direction, a radial direction, and a circumferential direction of the shaft 2, the turbine impeller 3, and the compressor impeller 4 may simply be referred to as the “axial direction,” the “radial direction,” and the “circumferential direction,” respectively, unless otherwise indicated. Furthermore, in the present disclosure, an axis of the shaft 2, the turbine impeller 3, and the compressor impeller 4 may simply be referred to as the “axis” unless otherwise indicated.

The housing 1 includes a bearing housing 5, a turbine housing 6, and a compressor housing 7. In the axial direction, one end of the bearing housing 5 is connected to the turbine housing 6. In the axial direction, the other end of the bearing housing 5 is connected to the compressor housing 7.

The bearing housing 5 includes a bearing hole 5a. The bearing hole 5a extends in the axial direction in the bearing housing 5. The bearing hole 5a accommodates a bearing B. The bearing B rotatably supports the shaft 2. In the present embodiment, a semi-floating bearing is used as the bearing B. In other embodiments, other radial bearings such as a full-floating bearing or a rolling bearing may be used as the bearing B.

In the axial direction, the turbine impeller 3 is provided at a first end of the shaft 2. The turbine impeller 3 rotates integrally with the shaft 2. The turbine housing 6 rotatably accommodates the turbine impeller 3. In the axial direction, the compressor impeller 4 is provided at a second end that is opposite to the first end in the shaft 2. The compressor impeller 4 rotates integrally with the shaft 2. The compressor housing 7 rotatably accommodates the compressor impeller 4.

The compressor housing 7 includes an inlet 71 at an end opposite to the bearing housing 5 in the axial direction. The inlet 71 is connected to an air cleaner (not shown).

The bearing housing 5 and the compressor housing 7 define a diffuser flow path 72 therebetween. The diffuser flow path 72 has an annular shape. The diffuser flow path 72 is positioned radially outside the compressor impeller 4. The diffuser flow path 72 is fluidly connected to the inlet 71 via the compressor impeller 4.

The compressor housing 7 includes a compressor scroll flow path 73. The compressor scroll flow path 73 is positioned radially outside the diffuser flow path 72. The compressor scroll flow path 73 is connected to the diffuser flow path 72. Furthermore, the compressor scroll flow path 73 is fluidly connected to an intake port of an engine (not shown).

As the compressor impeller 4 rotates, air is sucked into the compressor housing 7 through the inlet 71. While passing through the compressor impeller 4, the air is accelerated and pressurized by centrifugal force. While passing through the diffuser flow path 72 and the compressor scroll flow path 73, the air is further pressurized. The pressurized air flows out from an outlet opening (not shown) and is directed to the intake port of the engine. In the turbocharger TC, a part including the compressor impeller 4 and the compressor housing 7 functions as a centrifugal compressor C.

The turbine housing 6 includes an outlet 61 at an end opposite to the bearing housing 5 in the axial direction. The outlet 61 is connected to an exhaust gas purifier (not shown).

The turbine housing 6 includes a connecting flow path (annular flow path) 62. The connecting flow path 62 has an annular shape. The connecting flow path 62 is positioned radially outside the turbine impeller 3. The connecting flow path 62 is fluidly connected to the outlet 61 via the turbine impeller 3. A nozzle drive mechanism 20 is provided in the connecting flow path 62. The nozzle drive mechanism 20 will be described later in detail.

The turbine housing 6 includes a turbine scroll flow path 63. The turbine scroll flow path 63 is positioned radially outside the connecting flow path 62. The turbine scroll flow path 63 is connected to the connecting flow path 62. Furthermore, the turbine scroll flow path 63 is fluidly connected to a gas inlet opening (not shown). The gas inlet opening receives exhaust gas discharged from an exhaust manifold of the engine (not shown).

The exhaust gas is directed from the gas inlet opening into the turbine scroll flow path 63 and further directed through the connecting flow path 62 and the turbine impeller 3 to the outlet 61. While passing through the turbine impeller 3, the exhaust gas rotates the turbine impeller 3. Rotational force of the turbine impeller 3 is transmitted to the compressor impeller 4 via the shaft 2. As the compressor impeller 4 rotates, the air is pressurized as described above. As such, the pressurized air is directed to the intake port of the engine. In the turbocharger TC, a part including the turbine impeller 3 and the turbine housing 6 functions as the turbine T.

When a flow rate of the exhaust gas from the engine changes, a rotational rate of the turbine impeller 3, i.e., a rotational rate of the compressor impeller 4, changes. Consequently, depending on operating conditions of the engine, the air may not be pressurized as intended in the centrifugal compressor C. The nozzle drive mechanism 20 addresses such an issue.

The nozzle drive mechanism 20 adjusts a cross-sectional area of the connecting flow path 62. As the cross-sectional area of the connecting flow path 62 changes, a flow velocity of the exhaust gas directed to the turbine impeller 3 also changes. Specifically, when a rotational rate of the engine is low and the flow rate of the exhaust gas is low, the nozzle drive mechanism 20 reduces the cross-sectional area of the connecting flow path 62. As a result, the flow velocity of the exhaust gas directed to the turbine impeller 3 increases. Accordingly, the nozzle drive mechanism 20 enables the turbine impeller 3 to rotate with the low-flow rate exhaust gas.

Next, the nozzle drive mechanism 20 will be described in detail.

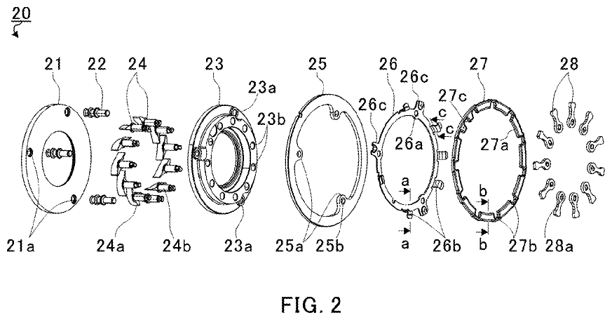

FIG. 2 is an exploded perspective view of the nozzle drive mechanism 20. The nozzle drive mechanism 20 includes a first plate 21, a plurality of pins 22, a second plate 23, a plurality of nozzle vanes 24, a third plate 25, a support ring 26, a drive ring 27, and a plurality of link plates 28. The nozzle drive mechanism 20 may further include other components.

The first plate 21 has an annular shape. Referring to FIG. 1, in the present embodiment, the first plate 21 is mounted on the turbine housing 6. The first plate 21 is arranged coaxially with the turbine impeller 3.

Referring to FIG. 2, the first plate 21 includes a plurality of first pin holes 21a that are arranged spaced apart from each other in the circumferential direction. For example, the plurality of first pin holes 21a may be arranged at equal intervals in the circumferential direction. In other embodiments, the plurality of first pin holes 21a may be arranged at different intervals in the circumferential direction. The first pin holes 21a pass through the first plate 21 in the axial direction. A first end of the pin 22 is inserted into each of the first pin holes 21a. Accordingly, the number of first pin holes 21a corresponds to the number of pins 22.

The second plate 23 has an annular shape. The second plate 23 is arranged coaxially with the first plate 21. The first plate 21 and the second plate 23 are spaced apart from each other in the axial direction. Referring to FIG. 1, the connecting flow pathway 62 is defined between the first plate 21 and the second plate 23.

Referring to FIG. 2, the second plate 23 includes a plurality of second pin holes 23a that are arranged spaced apart from each other in the circumferential direction. For example, the plurality of second pin holes 23a may be arranged at equal intervals in the circumferential direction. In other embodiments, the plurality of second pin holes 23a may be arranged at different intervals in the circumferential direction. The second pin holes 23a pass through the second plate 23 in the axial direction. The second pin holes 23a face the first pin holes 21a in the axial direction. A second end of the pin 22 is inserted into each of the second pin holes 23a. Accordingly, the number of second pin holes 23a corresponds to the number of pins 22.

The pin 22 includes a flange for axially positioning the first plate 21 and the second plate 23, and these flanges define a distance between the first plate 21 and the second plate 23. In the present embodiment, three pins 22 are used. The number of pins 22 is not limited thereto, and, for example, one, two, or four or more pins 22 may be used.

The second plate 23 includes a plurality of first shaft holes 23b that are arranged spaced apart from each other in the circumferential direction. The plurality of first shaft holes 23b are arranged at equal intervals in the circumferential direction. The first shaft holes 23b pass through the second plate 23 in the axial direction. For example, the first shaft holes 23b are positioned radially inside the second pin holes 23a. The number of first shaft holes 23b corresponds to the number of nozzle vanes 24.

Referring to FIG. 1, in the connecting flow path 62, the plurality of nozzle vanes 24 are arranged spaced apart from each other in the circumferential direction. The plurality of nozzle vanes 24 are arranged radially outside the turbine impeller 3. Referring to FIG. 2, in the present embodiment, eleven nozzle vanes 24 are used. The number of nozzle vanes 24 is not limited thereto. The nozzle vane 24 includes a vane body 24a and a shaft 24b.

The vane bodies 24a are arranged in a gap between the first plate 21 and the second plate 23, i.e., the connecting flow path 62. The shaft 24b extends from the vane body 24a in the axial direction. The shaft 24b is inserted into the first shaft hole 23b of the second plate 23. Accordingly, the plurality of nozzle vanes 24 are arranged at equal intervals in the circumferential direction. The nozzle vane 24 is rotatably supported by the first shaft hole 23b. The nozzle vane 24 is rotatable around respective axis that is parallel to the axis of the turbine impeller 3. In the present embodiment, the nozzle vane 24 is only supported by the second plate 23. In other embodiments, the nozzle vane 24 may include another shaft (not shown) protruding in a direction opposite to the shaft 24b, and may also be supported by the first plate 21 by inserting this shaft into a hole (not shown) formed in the first plate 21.

The third plate 25 has an annular shape. The third plate 25 is arranged coaxially with the first plate 21 and the second plate 23. In the axial direction, the third plate 25 is positioned opposite to the first plate 21 across the second plate 23. Referring to FIG. 1, for example, a radially outer part of the third plate 25 is held by the bearing housing 5 and the turbine housing 6.

Referring to FIG. 2, the third plate 25 includes a plurality of protrusions 25a that are arranged spaced apart from each other in the circumferential direction. For example, the plurality of protrusions 25a may be arranged at equal intervals in the circumferential direction. In other embodiments, the plurality of protrusions 25a may be arranged at different intervals in the circumferential direction. The protrusions 25a protrude radially inward from an inner circumferential surface of the third plate 25. The protrusions 25a include third pin holes 25b. The third pin hole 25b passes through the protrusion 25a in the axial direction. The third pin holes 25b face the second pin holes 23a in the axial direction. The second end of the pin 22 is inserted into the third pin hole 25b. Accordingly, the number of third pin holes 25b corresponds to the number of pins 22.

The support ring 26 has an annular shape. The support ring 26 is arranged coaxially with the first plate 21, the second plate 23, and the third plate 25. The support ring 26 is arranged opposite to the second plate 23 across the third plate 25 in the axial direction.

The support ring 26 includes a plurality of fourth pin holes 26a that are arranged spaced apart from each other in the circumferential direction. For example, the plurality of fourth pin holes 26a may be arranged at equal intervals in the circumferential direction. In other embodiments, the plurality of fourth pin holes 26a may be arranged at different intervals in the circumferential direction. The fourth pin holes 26a pass through the support ring 26 in the axial direction. The fourth pin holes 26a face the third pin holes 25b in the axial direction. The second end of the pin 22 is inserted into the fourth pin hole 26a. Accordingly, the number of fourth pin holes 26a corresponds to the number of pins 22.

As described above, the pin 22 is inserted into the first pin hole 21a, the second pin hole 23a, the third pin hole 25b, and the fourth pin hole 26a. The first ends and the second ends of the pins 22 are swaged.

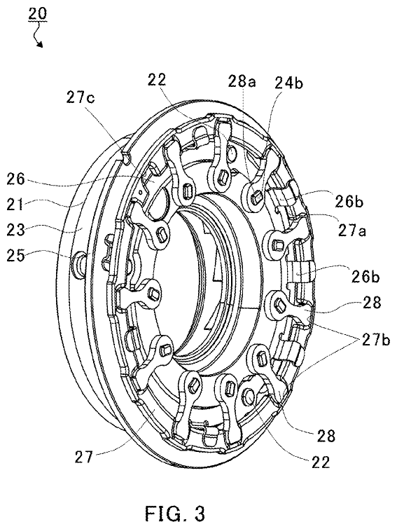

FIG. 3 is a perspective view of the nozzle drive mechanism 20 after assembly. As described above, when the first ends and the second ends of the pins 22 are swaged, the first plate 21, the second plate 23, the third plate 25, and the support ring 26 are fixed to each other by the plurality of pins 22. Furthermore, referring to FIG. 1, as described above, the first plate 21 is mounted to the turbine housing 6 and the radially outer part of the third plate 25 is held by the bearing housing 5 and the turbine housing 6. As such, the first plate 21, the second plate 23, the third plate 25, and the support ring 26 are fixed to the bearing housing 5 and the turbine housing 6.

Referring to FIG. 2, the support ring 26 includes a plurality of first protrusions 26b that are arranged spaced apart from each other in the circumferential direction. For example, the plurality of first protrusions 26b may be arranged at different intervals in the circumferential direction. In other embodiments, the plurality of first protrusions 26b may be arranged at equal intervals in the circumferential direction. The first protrusions 26b protrude from an outer peripheral edge of the support ring 26 in a direction opposite to the third plate 25 in the axial direction. In the present embodiment, six first protrusions 26b are used. The number of first protrusions 26b is not limited thereto. An end of the first protrusion 26b is bent radially outward. Accordingly, the first protrusion 26b has a substantially L-shape.

The support ring 26 includes a plurality of second protrusions 26c that are arranged spaced apart from each other in the circumferential direction. For example, the plurality of second protrusions 26c may be arranged at equal intervals in the circumferential direction. In other embodiments, the plurality of second protrusions 26c may be arranged at different intervals in the circumferential direction. The second protrusions 26c protrude radially outward from an outer circumferential surface of the support ring 26. The second protrusions 26c are arranged at positions different from the first protrusions 26b in the circumferential direction.

The drive ring 27 has an annular shape. The drive ring 27 is arranged coaxially with the first plate 21, the second plate 23, the third plate 25, and the support ring 26. The drive ring 27 is positioned in the axial direction by the support ring 26. Specifically, the drive ring 27 is positioned in the axial direction between the bent end of the first protrusion 26b and the second protrusion 26c. Accordingly, axial movement of the drive ring 27 is restricted by the bent end of the first protrusion 26b and the second protrusion 26c. An inner circumferential surface 27a of the drive ring 27 contacts outer surfaces of the first protrusions 26b (described later in detail).

An end of the shaft 24b of the nozzle vane 24 protrudes from the first shaft hole 23b of the second plate 23 in the axial direction, and is further inserted into a second shaft hole 28a of the link plate 28.

Referring to FIG. 3, as described above, the end of the shaft 24b of the nozzle vane 24 protrudes from the second shaft hole 28a of the link plate 28 and is then swaged. In this manner, the nozzle vane 24 and the link plate 28 are fixed to each other. The number of link plates 28 corresponds to the number of nozzle vanes 24.

Referring to FIG. 2, the link plate 28 has an elongated shape. In the present embodiment, the link plate 28 has a substantially pear shape. The plurality of link plates 28 are arranged spaced apart from each other in the circumferential direction on an inner side the drive ring 27. The aforementioned second shaft hole 28a is formed at a radially inner end of the link plate 28.

A plurality of first grooves 27b arranged spaced apart from each other in the circumferential direction are formed on the inner circumferential surface 27a of the drive ring 27. The first grooves 27b are recessed radially outward from the inner circumferential surface 27a. Referring to FIG. 3, radially outer ends of the link plates 28 are inserted into the first grooves 27b. The number of first grooves 27b is equal to the number of link plates 28. The plurality of first grooves 27b are arranged at equal intervals in the circumferential direction. Accordingly, the link plates 28 are also arranged at equal intervals in the circumferential direction.

Referring to FIG. 2, a single second groove 27c is formed on the inner circumferential surface 27a of the drive ring 27. The second groove 27c has a shape substantially similar to the first groove 27b. The second groove 27c is formed between a pair of consecutive first grooves 27b.

Referring to FIG. 3, the second groove 27c receives a circumferential (tangential) force from an actuator via a link (not shown). Accordingly, the drive ring 27 rotates in the circumferential direction around the plurality of first protrusions 26b of the support ring 26 that is fixed to the bearing housing 5 and turbine housing 6 (not shown in FIG. 3). As the drive ring 27 rotates, each link plate 28 and its corresponding shaft 24b rotate around the axis of the shaft 24b. Consequently, as shown in FIG. 2, the plurality of vane bodies 24a connected to the shafts 24b are simultaneously rotated, thereby adjusting the cross-sectional area of the connecting flow path 62.

As described above, the drive ring 27 rotates around the plurality of first protrusions 26b. Accordingly, the inner circumferential surface 27a of the drive ring 27 slides against the outer surfaces of the first protrusions 26b. In the present disclosure, the drive ring 27 is configured to reduce wear associated with the sliding.

Next, the drive ring 27 and the first protrusions 26b will be described in detail.

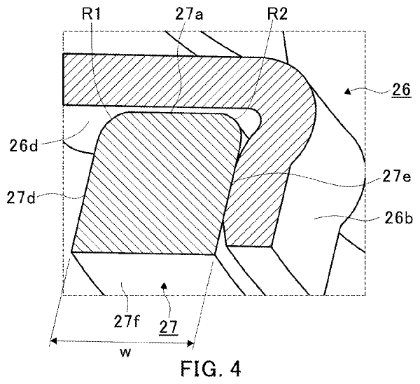

FIG. 4 is a schematic perspective view after assembly which includes cross-sections of the drive ring 27 and the first protrusions 26b obtained along line a-a and line b-b in FIG. 2. Note that while the drive ring 27 and first protrusion 26b are disassembled in FIG. 2, FIG. 4 shows cross-sections of the drive ring 27 and the first protrusion 26b after assembly. FIG. 4 shows the cross-sections along the axis of the turbine impeller 3.

The first protrusion 26b includes an outer surface 26d. The outer surface 26d faces radially outward.

The drive ring 27 includes, in addition to the aforementioned inner circumferential surface 27a, a first end face 27d, a second end face 27e, and an outer circumferential surface 27f.

The inner circumferential surface 27a and the outer circumferential surface 27f are positioned opposite to each other in the radial direction. The inner circumferential surface 27a faces radially inward. The outer circumferential surface 27f faces radially outward. In the present embodiment, each of the inner circumferential surface 27a and the outer circumferential surface 27f has a straight-line shape in the cross-section shown in FIG. 4.

The first end face 27d and the second end face 27e are positioned opposite to each other in the axial direction. Each of the first end face 27d and the second end face 27e is perpendicular to the axial direction. The first end face 27d is arranged closer to the connecting flow path 62 (not shown in FIG. 4) with respect to the second end face 27e. In the present embodiment, each of the first end face 27d and the second end face 27e has a straight-line shape in the cross-section shown in FIG. 4.

In the cross-section shown in FIG. 4, the inner circumferential surface 27a and the first end face 27d are connected to each other by a first R-shape R1. In other words, in the cross-section shown in FIG. 4, a corner between the inner circumferential surface 27a and the first end face 27d is rounded. In yet other words, in the cross-section shown in FIG. 4, the inner circumferential surface 27a and the first end face 27d are connected to each other by an arc shape.

In the cross-section shown in FIG. 4, the first R-shape R1 is connected to the inner circumferential surface 27a by a tangent of the first R-shape R1. In other words, the first R-shape R1 is smoothly connected to the inner circumferential surface 27a without an edge. Similarly, the first R-shape R1 is connected to the first end face 27d by a tangent of the first R-shape R1, i.e., the first R-shape R1 is smoothly connected to the first end face 27d without an edge.

In the cross-section shown in FIG. 4, the inner circumferential surface 27a and the second end face 27e are connected to each other by a second R-shape R2. In other words, in the cross-section shown in FIG. 4, a corner between the inner circumferential surface 27a and the second end face 27e is rounded. In yet other words, in the cross-section shown in FIG. 4, the inner circumferential surface 27a and the second end face 27e are connected to each other by an arc shape.

In the cross-section shown in FIG. 4, the second R-shape R2 is connected to the inner circumferential surface 27a by a tangent of the second R-shape R2. In other words, the second R-shape R2 is smoothly connected to the inner circumferential surface 27a without an edge. Similarly, the second R-shape R2 is connected to the second end face 27e by a tangent of the second R-shape R2, i.e., the second R-shape R2 is smoothly connected to the second end face 27e without an edge.

In the present embodiment, in the cross-section shown in FIG. 4, a radius of curvature of the first R-shape R1 is 6% or more of a width w of the drive ring 27 in the axial direction. Furthermore, in the cross-section shown in FIG. 4, the radius of curvature of the first R-shape R1 is 45% or less of the width w. Similarly, in the cross-section shown in FIG. 4, a radius of curvature of the second R-shape R2 is 6% or more of the width w. Furthermore, in the cross-section shown in FIG. 4, the radius of curvature of the second R-shape R2 is 45% or less of the width w.

According to such a configuration, since the inner circumferential surface 27a of the drive ring 27 includes the first R-shape R1 and the second R-shape R2 at both ends in the axial direction, the outer surfaces 26d of the first protrusions 26b can avoid contact with sharp edges. Accordingly, wear of the first protrusions 26b caused by the rotation of the drive ring 27 can be reduced.

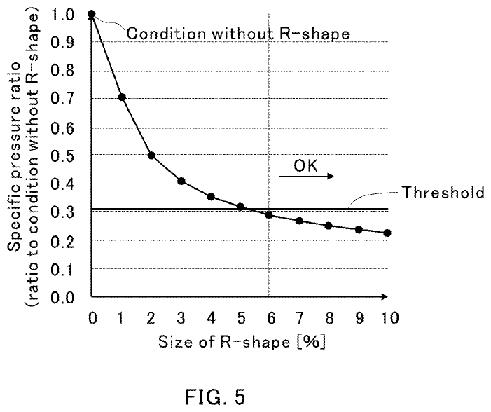

FIG. 5 is a graph showing a relationship between a size of R-shape and a specific pressure ratio. FIG. 5 analyzes specific pressure applied to a contact area between the inner circumferential surface 27a of the drive ring 27 and the outer surface 26d of the first protrusion 26b when the nozzle drive mechanism 20 operates under a rated condition. Note that the relationship shown in FIG. 5 applies to both the first R-shape R1 and the second R-shape R2.

In FIG. 5, a horizontal axis shows a size of R-shape, specifically a ratio (%) of the radius of curvature of R-shape to the width w of the drive ring 27. A vertical axis shows a specific pressure ratio, specifically a ratio of a specific pressure under each condition to a specific pressure applied to the drive ring 27 without the first R-shape R1 and the second R-shape R2. A threshold indicates a specific pressure ratio corresponding to a plastic flow pressure of main material used for the first protrusion 26b, such as stainless steel like SUS310. Note that as the size of nozzle drive mechanism 20 increases, a load applied to the drive ring 27 and the first protrusion 26b also increases. Accordingly, it is assumed that a load per unit area remains approximately constant regardless of the size of nozzle drive mechanism 20.

As can be seen from FIG. 5, if the size of R-shape is 6% or more of the width w, the specific pressure ratio is below the threshold. Accordingly, if the size of R-shape is 6% or more of the width w, plastic deformation of the outer surface 26d of the first protrusion 26b can be curbed, thereby reducing wear on the outer surface 26d.

Referring to FIG. 4, the inventors found that the outer surface 26d of the first protrusion 26b wears more significantly particularly in an area contacting a corner of the drive ring 27 near the connecting flow path 62, i.e., the corner between the inner circumferential surface 27a and the first end face 27d. This may be attributed to various factors. For example, heat from exhaust gas flowing through the connecting flow path 62 may cause the support ring 26 to deform more significantly in the area near the connecting flow path 62. Consequently, in this area, the first protrusion 26b and the drive ring 27 may come into strong contact. Regarding another reason, when the first protrusion 26b contacts the drive ring 27, the end of the first protrusion 26b, i.e., the free end, can deform away from the drive ring 27. Consequently, the first protrusion 26b and the drive ring 27 may come into strong contact in an area near the fixed end, i.e., the area near the connecting flow path 62. Accordingly, forming a first R-shape R1 at the corner between the inner circumferential surface 27a and the first end face 27d can better reduce wear of the first protrusion 26b.

Furthermore, if the radius of curvature of each of the first R-shape R1 and the second R-shape R2 exceeds 45% of the width w of the drive ring 27, the contact area between the outer surface 26d of the first protrusion 26b and the inner circumferential surface 27a of the drive ring 27 may be formed substantially as a line shape, potentially increasing the specific pressure. Accordingly, the radius of curvature of each of the first R-shape R1 and the second R-shape R2 may be 45% or less.

For example, the drive ring 27 including the first R-shape R1 and the second R-shape R2 as described above may be manufactured by barrel polishing.

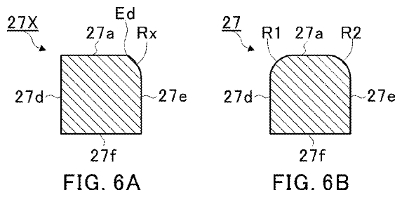

FIG. 6A is a schematic cross-sectional view showing a drive ring 27X after press forming and before barrel polishing. FIG. 6B is a schematic cross-sectional view showing the drive ring 27 after barrel polishing. Each of FIGS. 6A and 6B shows a cross-section along the axis of the turbine impeller 3.

Specifically, as shown in FIG. 6A, the drive ring 27X without the first R-shape R1 and the second R-shape R2 is formed by press forming, such as punching. During press forming, an inner peripheral edge of the second end face 27e may be pulled in the axial direction due to the punching, forming an R-shape Rx at a corner between the inner circumferential surface 27a and the second end face 27e. However, in this state, an edge Ed is formed between the inner circumferential surface 27a and the R-shape Rx. Furthermore, a corner between the inner circumferential surface 27a and the first end face 27d is formed sharply. In practice, the drive ring 27X in this state may be used in the nozzle drive mechanism 20.

However, in the present embodiment, the press-formed drive ring 27X is further polished by barrel polishing. In this way, the drive ring 27 including the first R-shape R1 and the second R-shape R2 is formed, as shown in FIG. 6B. In other embodiments, the first R-shape R1 and the second R-shape R2 may be formed on the drive ring 27 by other processing methods, such as machining.

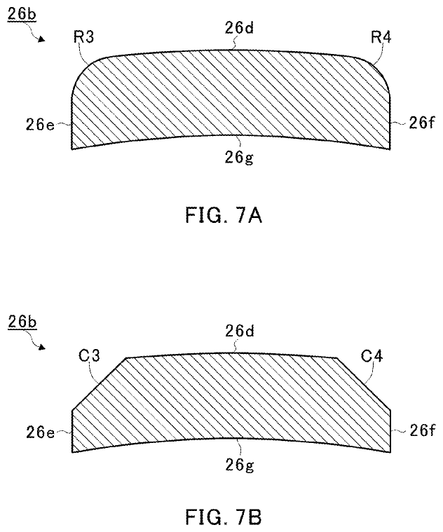

FIG. 7A is an example of a cross-sectional view of the first protrusion 26b obtained along line c-c in FIG. 2. FIG. 7B is another example of a cross-sectional view of the first protrusion 26b obtained along line c-c in FIG. 2. Each of FIGS. 7A and 7B shows a cross-section perpendicular to the axis of the turbine impeller 3.

Referring to FIG. 7A, the first protrusion 26b includes, in addition to the aforementioned outer surface 26d, a third end face 26e, a fourth end face 26f, and an inner surface 26g.

The outer surface 26d and the inner surface 26g are positioned opposite to each other in the radial direction. The inner surface 26g faces radially inward. The outer surface 26d faces radially outward. In the present embodiment, each of the inner surface 26g and the outer surface 26d has an arc shape in the cross-section of FIG. 7A. According to such a configuration, the outer surface 26d can extend along the inner circumferential surface 27a of the drive ring 27 in the circumferential direction. This contributes to reducing the specific pressure. In other embodiments, each of the inner surface 26g and the outer surface 26d may have a straight-line shape in the cross-section shown in FIG. 7A.

The third end face 26e and the fourth end face 26f are positioned opposite to each other in the circumferential direction. In the present embodiment, each of the third end face 26e and the fourth end face 26f has a straight-line shape in the cross-section shown in FIG. 7A.

In the cross-section of FIG. 7A, the outer surface 26d and the third end face 26e are connected to each other by a third R-shape R3. In other words, in the cross-section of FIG. 7A, a corner between the outer surface 26d and the third end face 26e is rounded. In yet other words, in the cross-section of FIG. 7A, the outer surface 26d and the third end face 26e are connected to each other by an arc shape.

In the cross-section of FIG. 7A, the third R-shape R3 is connected to the outer surface 26d by a tangent of the third R-shape R3. In other words, the third R-shape R3 is smoothly connected to the outer surface 26d without an edge. Similarly, the third R-shape R3 is connected to the third end face 26e by a tangent of the third R-shape R3, i.e., the third R-shape R3 is smoothly connected to the third end face 26e without an edge.

In the cross-section of FIG. 7A, the outer surface 26d and the fourth end face 26f are connected to each other by a fourth R-shape R4. In other words, in the cross-section of FIG. 7A, a corner between the outer surface 26d and the fourth end face 26f is rounded. In yet other words, in the cross-section of FIG. 7A, the outer surface 26d and the fourth end face 26f are connected to each other by an arc shape.

In the cross-section of FIG. 7A, the fourth R-shape R4 is connected to the outer surface 26d by a tangent of the fourth R-shape R4. In other words, the fourth R-shape R4 is smoothly connected to the outer surface 26d without an edge. Similarly, the fourth R-shape R4 is connected to the fourth end face 26f by a tangent of the fourth R-shape R4, i.e., the fourth R-shape R4 is smoothly connected to the fourth end face 26f without an edge.

According to such a configuration, since the outer surface 26d of the first protrusion 26b includes the third R-shape R3 and the fourth R-shape R4 at both ends in the circumferential direction, the inner circumferential surface 27a of the drive ring 27 (not shown in FIG. 7A) can avoid contact with sharp edges. Accordingly, wear of the drive ring 27 caused by the rotation of the drive ring 27 can be reduced.

Referring to FIG. 7B, in this example, the outer surface 26d and the third end face 26e are connected to each other by a third chamfer C3 instead of the third R-shape R3. In other words, in the cross-section of FIG. 7B, the outer surface 26d and the third end face 26e are connected to each other by a straight-line shape. Furthermore, the outer surface 26d and the fourth end face 26f are connected to each other by a fourth chamfer C4 instead of a fourth R-shape R4. In other words, in the cross-section of FIG. 7B, the outer surface 26d and the fourth end face 26f are connected to each other by a straight-line shape. This configuration also achieves effects similar to those of the example in FIG. 7A.

The turbocharger TC as described above includes the turbine impeller 3, the housing 1 that accommodates the turbine impeller 3 and that includes the connecting flow path 62 formed radially outside the turbine impeller 3, the plurality of rotatable nozzle vanes 24 that are arranged in the connecting flow path 62 along the circumferential direction, the support ring 26 that has an annular shape around the axis of the turbine impeller 3 and that is accommodated in the housing 1, and the drive ring 27 that has an annular shape around the axis of the turbine impeller 3 and that rotates around the support ring 26 to simultaneously rotate the plurality of rotatable nozzle vanes 24. The drive ring 27 includes the inner circumferential surface 27a that contacts the support ring 26, and the first end face 27d and the second end face 27e in the axial direction. The first end face 27d is positioned closer to the connecting flow path 62 with respect to the second end face 27e in the axial direction. In the cross-section along the axis of the turbine impeller 3, the drive ring 27 includes the first R-shape R1 that connects the inner circumferential surface 27a to the first end face 27d. As described above, the inventors found that the outer surface 26d of the support ring 26 wears more in the area contacting the corner of the drive ring 27 near the connecting flow path 62, i.e., the corner between the inner circumferential surface 27a and the first end face 27d. According to the configuration described above, since the inner circumferential surface 27a of the drive ring 27 includes the first R-shape R1 at the aforementioned corner, the outer surface 26d of the support ring 26 can avoid contact with sharp edges. As such, wear of the support ring 26 caused by the rotation of the drive ring 27 can be reduced.

Furthermore, in the turbocharger TC, the first R-shape R1 is connected to the inner circumferential surface 27a by the tangent of the first R-shape R1 in the aforementioned cross-section. According to such a configuration, the first R-shape R1 is smoothly connected to the inner circumferential surface 27a without an edge, thereby further reducing wear.

Furthermore, in the turbocharger TC, the radius of curvature of the first R-shape R1 in the aforementioned cross-section is 6% or more of the width w of the drive ring 27 in the axial direction. As described above, if the size of R-shape is 6% or more of the width w, plastic deformation of the outer surface 26d of the support ring 26 can be substantially curbed, thereby further reducing wear on the outer surface 26d.

Furthermore, in the turbocharger TC, the radius of curvature of the first R-shape R1 in the aforementioned cross-section is 45% or less of the width w. This configuration avoids forming a linear contact area between the drive ring 27 and the support ring 26.

Furthermore, in the turbocharger TC, the drive ring 27 includes the second R-shape R2 that connects the inner circumferential surface 27a to the second end face 27e in the aforementioned cross-section. This configuration further reduces wear on the support ring 26 caused by the rotation of the drive ring 27.

Furthermore, in the turbocharger TC, the support ring 26 includes the plurality of first protrusions 26b that protrude in the axial direction and that contact the inner circumferential surface 27a of the drive ring 27. Each of the plurality of first protrusions 26b includes the outer surface 26d that contacts the inner circumferential surface 27a of the drive ring 27, and the third end face 26e and the fourth end face 26f in the circumferential direction. In one example, each of the plurality of first protrusions 26b includes, in the cross-section perpendicular to the axis of the turbine impeller 3, the third R-shape R3 that connects the outer surface 26d to the third end face 26e, and the fourth R-shape R4 that connects the outer surface 26d to the fourth end face 26f. In another example, each of the plurality of first protrusions 26b includes, in the aforementioned cross-section, the third chamfer C3 that connects the outer surface 26d to the third end face 26e, and the fourth chamfer C4 that connects the outer surface 26d to the fourth end face 26f. According to these configurations, wear of the drive ring 27 caused by rotation of the drive ring 27 can be reduced.

Although the embodiment of the present disclosure has been described above with reference to the accompanying drawings, the present disclosure is not limited thereto. It is obvious that a person skilled in the art can conceive of various examples of variations or modifications within the scope of the claims, which are also understood to belong to the technical scope of the present disclosure.

What is claimed is:

1. A turbocharger comprising:
a turbine impeller;
a housing that accommodates the turbine impeller and that includes an annular flow path formed radially outside the turbine impeller;
a plurality of rotatable nozzle vanes that are arranged in the annular flow path along a circumferential direction of the turbine impeller,
a support ring that has an annular shape around an axis of the turbine impeller and that is accommodated in the housing; and
a drive ring that has an annular shape around the axis of the turbine impeller and that rotates around the support ring to simultaneously rotate the plurality of rotatable nozzle vanes, the drive ring including:
an inner circumferential surface that contacts the support ring; and
a first end face and a second end face in an axial direction of the turbine impeller,
the first end face being arranged closer to the annular flow path with respect to the second end face in the axial direction,
the drive ring including, in a cross-section along the axis of the turbine impeller, a first shape that has a round shape or an arc shape and connects the inner circumferential surface to the first end face.

2. The turbocharger according to claim 1, wherein, in the cross-section, the first shape is connected to the inner circumferential surface by a tangent of the first shape.

3. The turbocharger according to claim 1, wherein, in the cross-section, a radius of curvature of the first shape is 6% or more of a width of the drive ring in the axial direction.

4. The turbocharger according to claim 3, wherein, in the cross section, the radius of curvature of the first shape is 45% or less of the width of the drive ring.

5. The turbocharger according to claim 1, wherein the drive ring includes, in the cross section, a second shape that has a round shape or an arc shape and connects the inner circumferential surface to the second end face.

6. The turbocharger according to claim 1, wherein the support ring includes a plurality of protrusions that protrude in the axial direction and that contacts the inner circumferential surface of the drive ring,
each of the plurality of protrusions includes an outer surface that contacts the inner circumferential surface of the drive ring, and a third end face and a fourth end face in the circumferential direction, and
each of the plurality of protrusions includes, in a cross-section perpendicular to the axis of the turbine impeller, a third shape that has a round shape or an arc shape and connects the outer surface to the third end face and a fourth shape that has a round shape or an arc shape and connects the outer surface to the fourth end face.

7. The turbocharger according to claim 1, wherein the support ring includes a plurality of protrusions that protrude in the axial direction and that contacts the inner circumferential surface of the drive ring,
each of the plurality of protrusions includes an outer surface that contacts the inner circumferential surface of the drive ring, and a third end face and a fourth end face in the circumferential direction, and
each of the plurality of protrusions includes, in a cross-section perpendicular to the axis of the turbine impeller, a third chamfer that connects the outer surface to the third end face and a fourth chamfer that connects the outer surface to the fourth end face.
